(19) United States
(12) Patent Application Publication
(10) Pub. No.: US 2020/0033001 A1
(43) Pub. Date: Jan. 30, 2020

(54) METHOD FOR VISUALIZING COMBUSTION OF A FUEL-AIR MIXTURE

(71) Applicant: Dr. Ing. h.c. F. Porsche Aktiengesellschaft, Stuttgart (DE)

(72) Inventors: Patrick Feuerer, Altdorf (DE); Timo Combe, Magstadt (DE)

(21) Appl. No.: 16/449,810

(22) Filed: Jun. 24, 2019

(30) Foreign Application Priority Data
Jun. 22, 2018 (DE) 10 2018 115 022.9

(51) Int. Cl. F23N 5/08; F02D 41/14; G01M 15/10

(52) U.S. Cl. CPC F23N 5/082; G01M 15/108; F02D 41/1466

(57) ABSTRACT

A method is provided for visualizing a combustion process of a fuel-air mixture within a combustion chamber of an internal combustion engine. Flame light signals that are generated during the combustion of the fuel-air mixture within the combustion chamber are detected in a number of detection volumes (20) by a multi-channel optical measuring probe (2) and the light intensities of the flame light signals are evaluated and graphically visualized by an evaluating and visualizing device (5). Information concerning the position of the flame is provided by flame light signals within the detection volumes (20) and by the formation of hypotheses and by the selection of a most probable hypothesis by means of a mathematical assessment algorithm implemented in the evaluating and visualizing device (5) and are graphically visualized by the evaluating and visualizing device (5).

### CROSS REFERENCE TO RELATED APPLICATION

This application claims priority under 35 USC 119 to German Patent Appl. No. 10 2018 115 022.9 filed on Jun. 22, 2018, the entire disclosure of which is incorporated herein by reference.

### BACKGROUND

Field of the Invention The present invention relates to a method for visualizing a combustion process of a fuel-air mixture within a combustion chamber of an internal combustion engine, flame light signals that are generated during the combustion of the fuel-air mixture within the combustion chamber being detected in a number of detection volumes by means of a multi-channel optical measuring probe and the light intensities of the flame light signals being evaluated and graphically visualized by an evaluating and visualizing device.

The combustion of a fuel-air mixture within a combustion chamber of an internal combustion engine causes light radiation, which is primarily made up of chemiluminescence and so-called soot luminosity. In the oxidation of CH molecules in the combustion chamber, intermediate and end products are produced, passing through various states of molecular excitation. The light radiation thereby produced is referred to as chemiluminescence. The soot luminosity is thermal radiation of soot particles, which is produced in diffusion flames and, because of its spectral wavelength, is visible to the human eye.

A measurement of the light intensity of the light radiation generated within the combustion chamber during the combustion process by detecting flame light signals allows conclusions to be drawn in particular about the nature and quality of the combustion process of the fuel-air mixture. It is thus possible for example in the evaluation of combustion processes to detect situations in which the fuel-air mixture intended for the combustion has not been prepared sufficiently, with the result in particular that misfiring or other irregular combustion processes may occur, and under some circumstances may have adverse effects on the emission characteristics of the internal combustion engine.

Related Art EP 1 998 032 B1 discloses a method for assessing a combustion process of a fuel-air mixture which makes it possible in particular to analyze the homogeneity of the combustion process that takes place within the combustion chamber of an internal combustion engine. An interpretation and assessment of the measurement results, which represent the light intensities obtained from flame light signals within the combustion chamber of the internal combustion engine, are typically performed with the aid of a number of two-dimensional diagrams, which can be graphically visualized by means of an evaluating and visualizing device, which evaluates the measurement results and prepares them in a suitable way. As a result, however, it is only possible to isolate the measured light intensities to a specific detection volume within the combustion chamber of the internal combustion engine. Furthermore, directional information can be extracted from the measured flame light signals. Apart from the light intensity in the combustion chamber and the directional information, the crankshaft angle (measured in ° CA) can be used also to assign “time information” to the flame light signals. Consequently, it is not directly evident from these two-dimensional diagrams that are used for the test evaluation and assessment of the combustion process of the fuel-air mixture at which location of the detection volume the flame that generated the flame light signal detected by the measuring instruments was located.

It is therefore an object of the present invention to provide a further improved method for visualizing a combustion process of a fuel-air mixture in a combustion chamber of an internal combustion engine that makes it possible in particular for the combustion process to be assessed more easily.

### SUMMARY

A method according to the invention for visualizing a combustion process of a fuel-air mixture in a combustion chamber of an internal combustion engine is distinguished by the fact that information concerning the position of the flame is provided by flame light signals within the detection volumes and by the formation of hypotheses and by the selection of a most probable hypothesis by means of a mathematical assessment algorithm implemented in the evaluating and visualizing device and is graphically visualized by the evaluating and visualizing device. The invention provides that the information previously missing in the evaluation of the flame light signals concerning their positions within the detection volumes is made available by the formation and assessment of hypotheses. These hypotheses comprise possible locations of the production of the flame and possible types of flame propagation within the combustion chamber of the internal combustion engine. Implemented in the evaluating and visualizing device is a mathematical assessment algorithm, by means of which an assessment of the most probable hypothesis is performed. This creates the possibility of also obtaining the flame position along the longitudinal axes of the detection volumes, since the information necessary for this, which was previously missing, can be provided by the formation of a hypothesis and its assessment. This additional information is incorporated in the graphical visualization and makes an easier assessment of the combustion process possible.

The flame light signals may be detected in a number of different planes within the combustion chamber. For this purpose, individual measuring devices of the multi-channel optical measuring probe, which may be formed in particular by optical fibers, may be arranged in different detection planes within the combustion chamber.

In one embodiment, a time signal, in particular a crank angle signal, to which the flame light signals are assigned is detected. As a result, the variation over time of the flame light signals can be analyzed, so that for example information concerning the causes of increased emissions of the internal combustion engine can be obtained and graphically visualized.

To make a particularly easy and intuitive evaluation or assessment of the flame light signals possible, a representation of the combustion process of the fuel-air mixture as a three-dimensional animation is generated and graphically visualized by the evaluating and visualizing device.

Features that are evaluated by the mathematical assessment algorithm for differentiating between the hypotheses may be the propagation of the flame light signals in the individual sensor channels of the multi-channel optical measuring probe, preferably in the different sensor planes of the measuring probe, and/or the intensity in comparison with a premixed fraction and/or the point in time of the light radiation that leads to the detected flame light signals and/or the time duration of the flame light signals.

A plurality of influencing variables may assessed by the mathematical assessment algorithm with respect to with which individual probability each of these influencing variables contributes to the formation of one of the hypotheses. Examples of such influencing variables for the assessment of the most probable hypothesis with respect to an injector of the internal combustion engine are in particular the injector type, the injector position, the injector state and the direction-dependent quantitative breakdown of the fuel, with respect to the application are in particular the injection pressure, the quantitative breakdown over time of the fuel, the injection timing and the valve control times and the ignition point. With respect to the flow conditions, important influencing variables are: swirl, tumble and the level of turbulence. With respect to the piston geometry, important influencing variables are in particular the designs of the piston recess and the valve reliefs. These influencing variables are merely given by way of example. Further influencing variables may be incorporated in the assessment.

The mathematical assessment algorithm may form from the individual probabilities an overall probability of the occurrence of each individual hypothesis.

Additional auxiliary signals from the internal combustion engine may be received and processed by the evaluating and visualizing device and may be incorporated in the evaluation and visualization of the flame light signals. For example, these auxiliary signals may be pressure signals, in particular cylinder pressure signals, and/or ignition signals, in particular the ignition point, of the internal combustion engine.

Reference signals can be retrievably stored in the evaluating and visualizing device and compared with the measured flame light signals. This comparison may be performed in particular by visualization, in particular a visualization by three-dimensional animation, of the reference signals and the flame light signals.

The method can be used inter alia as an aid for a comparison of different injectors, for establishing injection strategies, for locating places where knocking occurs within the combustion chamber and for considering the flame propagation, can be carried out in particular on a static or dynamic engine test stand or else on a roller test stand for motor vehicles.

### BRIEF DESCRIPTION OF THE DRAWING

FIG. 1 is a schematic representation a measuring device for carrying out a method for visualizing a combustion process of a fuel-air mixture according to an exemplary embodiment of the invention.

### DETAILED DESCRIPTION

The combustion of a fuel-air mixture within a combustion chamber of an internal combustion engine causes light radiation, which is primarily made up of chemiluminescence and so-called soot luminosity. In the oxidation of CH molecules within the combustion chamber, intermediate and end products are produced, passing through various states of molecular excitation. The light radiation thereby produced is referred to as chemiluminescence. The soot luminosity is thermal radiation of soot particles, which is produced in diffusion flames and, because of its spectral wavelength, is visible to the human eye.

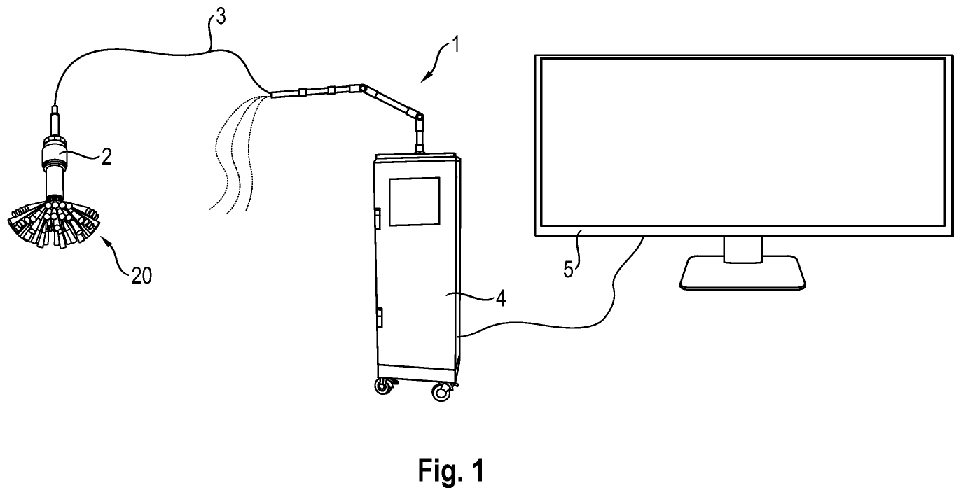

With reference to FIG. 1, the measuring device 1, which is designed for carrying out a method for visualizing a combustion process of a fuel-air mixture within the combustion chamber of an internal combustion engine, comprises a multi-channel optical measuring probe 2, which in the present case is designed as a spark plug and comprises a multiplicity of optical fibers, which in the intended fitted position partly extend into the combustion chamber of the internal combustion engine. These optical fibers can detect flame light signals that are generated during the combustion of a fuel-air mixture within the combustion chamber. The detection volume 20 of each of the optical fibers has been visualized in FIG. 1 respectively by a detection cone. The optical fibers may for example be arranged in four groups and placed in such a way that a first group can detect the flame light signals in a first plane, a second group can detect the flame light signals in a second plane, a third group can detect the flame light signals in a third plane and a fourth group can detect the flame light signals in a fourth plane within the combustion chamber. The optical fibers are led out from the optical measuring probe 2 by means of one or more light guides 3, within which they are arranged.

The measuring device 1 also comprises a measuring signal transducer 4, to which the light guide 3 or the light guides 3 is/are connected. The measuring signal transducer 4 preferably has a plurality of photodiodes and analog-digital converters. The photodiodes are designed to convert the flame light signals (intensity signals) transmitted by the optical fibers of the light guide 3 or the light guides 3 into analog electrical measuring signals. These analog electrical measuring signals are converted with the aid of the analog-digital converters of the measuring signal transducer 4 into digital measuring signals, which can be output by the measuring signal transducer 4 as output signals.

The measuring device 1 also has an evaluating and visualizing device 5, which is connected to the measuring signal transducer 4. The evaluating and visualizing device 5 is in particular designed to record, process and evaluate the digital measuring signals provided by the measuring signal transducer 4. Furthermore, the measuring signals, which provide information concerning the light intensities of the flame light signals within the combustion chamber of the internal combustion engine, can be graphically prepared and graphically visualized for a user by the evaluating and visualizing device 5. In addition, the evaluating and visualizing device 5 is preferably also designed to receive and process additional auxiliary signals from the internal combustion engine, which can likewise be incorporated in the evaluation and visualization of the measuring signals. For example, these auxiliary signals may be pressure signals, in particular cylinder pressure signals, and/or ignition signals of the internal combustion engine. Preferably, the evaluating and visualizing device 5 is also designed to calibrate the optical measuring probe 2 before the actual beginning of the measurements.

An interpretation and assessment of the measurement results that represent the measured light intensities of the flame light signals within the internal combustion engine may in principle be performed with the aid of a number of two-dimensional diagrams, which can be generated and graphically visualized by means of the evaluating and visualizing device 5. As a result, however, it is only possible to isolate the measured light intensities to a specific detection volume 20 within the combustion chamber of the internal combustion engine. In addition, directional information can also be extracted from the detected flame light signals, so that as a result conclusions can be drawn about the direction of flame propagation. However, it is not directly evident from these two-dimensional diagrams where exactly in the detection volume 20 the flame that generated the flame light signal detected by the measuring instruments was located. Apart from the light intensity in the combustion chamber, the crankshaft angle (measured in ° CA) can be used also to assign “time information” to the flame light signals. An interpretation and assessment of the measurement results provided in this form consequently involves a relatively great effort and requires well-founded expert knowledge.

To simplify the interpretation and assessment of the measuring signals that represent the flame light signals detected by measuring instruments within the combustion chamber of the internal combustion engine and are visualized by the evaluating and visualizing device 5, it is proposed that the information previously missing in the evaluation concerning the positions of the flame light signals within the detection volumes 20 is made available by the formation of hypotheses. These hypotheses comprise in particular possible locations of the production of the flame and possible types of flame propagation. Implemented in the evaluating and visualizing device 5 for this purpose is a mathematical assessment algorithm, by means of which an assessment of the most probable hypothesis is performed. This creates the possibility for the first time of also obtaining the flame positions along the longitudinal axes of the detection volumes 20, since the information necessary for this, which was previously missing, can be provided by the formation of a hypothesis. This additional information can be incorporated in the evaluation and visualization of the combustion process of the fuel-air mixture.

In a further method step, a representation of the combustion process of the fuel-air mixture as a three-dimensional animation is generated and visualized by the evaluating and visualizing device 5, so that an easy and clear evaluation and interpretation of the flame light signals can be performed.

When forming the hypotheses concerning the location of the production of the flame and the flame propagation, it may in particular be differentiated whether they

a) are causally due to the initiation of a combustion,

b) are causally due to the production of a diffusion flame,

c) are causally due to knocking or premature firing or

d) are not causally progressive.

Further differentiating criteria are possible in principle.

If the flame light signal is causally due to the initiation of a combustion, this is the reason for the hypothesis that the propagation of the flame takes place from the spark plug (location of production of the flame) in the direction of a piston assigned to this spark plug.

If the production of a diffusion flame is causal, it can be differentiated whether this is induced because of an inhomogeneous fuel-air mixture or because of a wetting with fuel, in particular at the locations in the combustion chamber of the valve or injector or liner or piston recess or valve relief or piston top land.

If the hypothesis that knocking or premature firing is causal for the production of the flame is proposed, it can be assumed that the knocking is produced in the vicinity of the piston top land and that the main source of the premature firing is the spark plug.

The mathematical assessment algorithm implemented in the evaluating and visualizing device 5 is designed to assess these different hypotheses and thereby determine the most probable correct hypothesis, so that this most probable hypothesis can make available the missing information concerning the location of the production of the flame and use it as a basis for the three-dimensional animation for the visualization of the flame light signals.

Important features for differentiating and visualizing the hypotheses that are incorporated in the mathematical assessment algorithm are in particular the propagation of the flames in the individual sensor channels or sensor planes of the multi-channel optical measuring probe 2, which are formed by the optical fibers, and in the different sensor planes, the intensity in comparison with the premixed fraction, the point in time of the light radiation (defined by the crankshaft angle, measured in ° CA) that leads to the detected flame light signal and the time duration of the light radiation.

Important influencing variables for the assessment of the most probable hypothesis with respect to the injector of the internal combustion engine are in particular the injector type, the injector position, the injector state and the direction-dependent quantitative breakdown of the fuel, with respect to the application are in particular the injection pressure, the quantitative breakdown over time of the fuel, the injection timing and the valve control times. With respect to the flow conditions, important influencing variables are: swirl, tumble and the level of turbulence. With respect to the piston geometry, important influencing variables are in particular the designs of the piston recess and the valve reliefs.

The mathematical assessment algorithm is designed to assess with which individual probability each of the individual influencing variables contributes to the formation of one of the hypotheses. In addition, the assessment algorithm forms from the individual probabilities an overall probability of the occurrence of each individual hypothesis. This is to be illustrated below on the basis of an example. If the internal combustion engine is equipped with a piezo injector (for example with a so-called A nozzle), the individual probability that this parameter contributes to the hypothesis that a measured flame light signal at the piezo injector is produced by so-called “tip sooting” is virtually zero. The overall probability that this hypothesis is correct is then consequently likewise virtually zero.

The method explained above for visualizing a combustion process of a fuel-air mixture in a combustion chamber of an internal combustion engine can be used in particular on a static or dynamic engine test stand or else on a roller test stand for motor vehicles. It can be used inter alia as an aid for a comparison of injectors, for establishing injection strategies, for locating places where knocking occurs and for considering the flame propagation within the combustion chamber of the internal combustion engine.

1. A method for visualizing a combustion process of a fuel-air mixture within a combustion chamber of an internal combustion engine, comprising: detecting, in a number of detection volumes, flame light signals that are generated during the combustion of the fuel-air mixture within the combustion chamber by means of a multi-channel optical measuring probe; graphically visualizing and evaluating light intensities of the flame light signals by an evaluating and visualizing device; providing information concerning the position of the flame by flame light signals within the detection volumes; forming hypotheses and selecting a most probable hypothesis by means of a mathematical assessment algorithm implemented in the evaluating and visualizing device and using the evaluating and visualizing device to graphically visualize the most probable hypothesis.

2. The method of claim 1, wherein the step of detecting the flame light signals comprises detecting the flame light signals in a number of different planes within the combustion chamber.

3. The method of claim 2, further comprising detecting a crank angle signal, to which the flame light signals are assigned.

4. The method of claim 1, further comprising using the evaluating and visualizing device for generating and visualizing a representation of the combustion process of the fuel-air mixture as a three-dimensional animation.

5. The method claim 1, using the mathematical assessment algorithm for differentiating between and assessing: propagation of the flame light signals in individual sensor channels of the multi-channel optical measuring probe, and/or intensity in comparison with a premixed fraction, and/or a point in time of light radiation that leads to the detected flame light signals, and/or time duration of the flame light signals.

6. The method of claim 1, further comprising using the mathematical assessment algorithm to assess a plurality of influencing variables with respect to with which individual probability each of these influencing variables contributes to the formation of one of the hypotheses.

7. The method of claim 6, wherein the mathematical assessment algorithm forms from the individual probabilities an overall probability of the occurrence of each individual hypothesis.

8. The method of claim 1, further comprising using the evaluating and visualizing device to receive and process additional auxiliary signals from the internal combustion engine and incorporating the auxiliary signals in the evaluation and visualization of the measuring signals.

9. The method of claim 1, further comprising retrievably storing reference signals in the evaluating and visualizing device and comparing the reference signals with the measured flame light signals.
